(19) United States
(12) Patent Application Publication
(10) Pub. No.: US 2024/0297941 A1
(43) Pub. Date: Sep. 5, 2024

(54) PRINTING DEVICE, METHOD FOR CONTROLLING PRINTING DEVICE, AND NON-TRANSITORY COMPUTER-READABLE STORAGE MEDIUM STORING PROGRAM

(71) Applicant: SEIKO EPSON CORPORATION, Tokyo (JP)

(72) Inventor: Kota NISHIDA, Shiojiri-shi (JP)

(21) Appl. No.: 18/592,034

(22) Filed: Feb. 29, 2024

(30) Foreign Application Priority Data
Mar. 3, 2023 (JP) 2023-032598

(51) Int. Cl. H04N 1/00

(52) U.S. Cl. CPC H04N 1/0023; H04N 1/00307

(57) ABSTRACT

A printing device includes: a connection processor configured to establish wireless communication connection with a plurality of terminal devices conforming to a NAN standard; a print information acquisition unit configured to acquire image data to be printed from any one of the plurality of terminal devices using the wireless communication connection; a printing unit configured to print the image data; and a transmission controller configured to perform control to transmit the image data to one or more terminal devices included in the plurality of terminal devices using the wireless communication connection when the image data is printed.

The present application is based on, and claims priority from JP Application Serial Number 2023-032598, filed Mar. 3, 2023, the disclosure of which is hereby incorporated by reference herein in its entirety.

### BACKGROUND

### 1. Technical Field

The present disclosure relates to a printing device, a method for controlling a printing device, and a non-transitory computer-readable storage medium storing a program.

### 2. Related Art

In Wi-Fi Aware which is one of Wi-Fi Alliance certification programs, a communication protocol called a neighbor awareness network (NAN), which wirelessly communicates between devices without using an access point, is defined. Hereinafter, a standard for the NAN defined by Wi-Fi Alliance is referred to as a NAN standard. JP-A-2019-134322 discloses a technique for implementing printing by transmitting data from a terminal device to a printing device using wireless communication conforming to the NAN standard.

JP-A-2019-134322 is an example of the related art.

### SUMMARY

In some cases, photographs taken in a hall such as a party hall where people gather are printed in the hall. Accordingly, it is possible to distribute the taken photographs to people who visit the hall. Recently, there are increasing people who want to own not only photographs as printed matters but also photographs as image data. However, when a network infrastructure environment is not provided in the hall, it is not easy for people to share the image data.

According to JP-A-2019-134322, even when a network infrastructure environment is not provided, a user can perform printing using the printing device in which the communication connection conforming to the NAN standard is established. However, in a technique described in the document, people cannot share the image data to be printed in a hall where a network infrastructure environment is not provided, and thus convenience is low.

A printing device according to the present disclosure includes: a connection processing unit configured to establish wireless communication connection with a plurality of terminal devices conforming to a NAN standard; a print information acquisition unit configured to acquire image data to be printed from any one of the plurality of terminal devices using the wireless communication connection; a printing unit configured to print the image data; and a transmission control unit configured to perform control to transmit the image data to one or more terminal devices included in the plurality of terminal devices using the wireless communication connection when the image data is printed.

A method for controlling a printing device according to the present disclosure includes: establishing wireless communication connection with a plurality of terminal devices conforming to a NAN standard; acquiring image data to be printed from any one of the plurality of terminal devices using the wireless communication connection; printing the image data; and performing control to transmit the image data to one or more terminal devices included in the plurality of terminal devices using the wireless communication connection when the image data is printed.

A non-transitory computer-readable storage medium storing a program according to the present disclosure causes a computer to execute: a connection processing step of establishing wireless communication connection with a plurality of terminal devices conforming to a NAN standard; a print information acquisition step of acquiring image data to be printed from any one of the plurality of terminal devices using the wireless communication connection; a printing processing step of performing processing of performing printing of the image data; and a transmission control step of performing control to transmit the image data to one or more terminal devices included in the plurality of terminal devices using the wireless communication connection when the image data is printed.

### BRIEF DESCRIPTION OF THE DRAWINGS

FIG. 1 is a schematic diagram showing an example of a configuration of a printing system according to an embodiment.

FIG. 2 is a block diagram showing an example of a configuration of a terminal device according to the embodiment.

FIG. 3 is a block diagram showing an example of a configuration of a printing device according to the embodiment.

FIG. 4 is a flowchart showing an example of an operation flow of the printing system according to the embodiment.

FIG. 5 is a block diagram showing an example of a configuration of a terminal device according to a modification.

FIG. 6 is a block diagram showing an example of a configuration of a printing device according to the modification.

FIG. 7 is a flowchart showing an example of an operation flow of a printing system according to the modification.

### DESCRIPTION OF EMBODIMENTS

Hereinafter, an embodiment will be described with reference to the drawings. To clarify the description, the following description and drawings are omitted and simplified as appropriate. In the drawings, the same elements are denoted by the same reference signs, and the redundant description thereof is omitted as necessary.

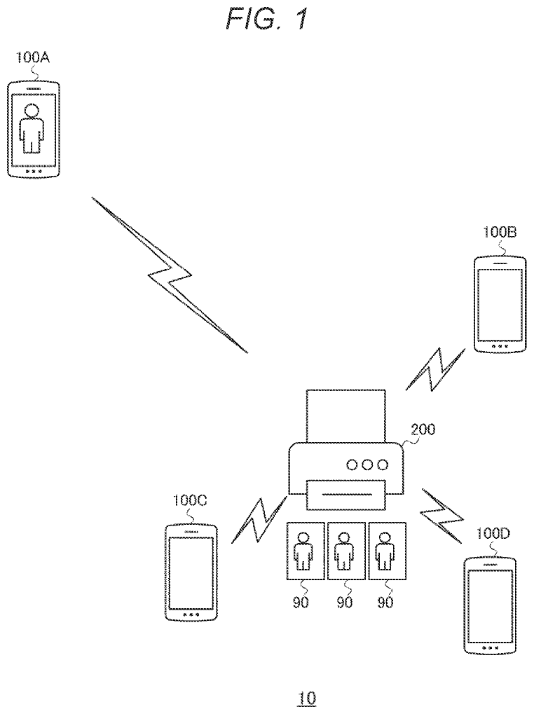

FIG. 1 is a schematic diagram showing an example of a configuration of a printing system 10 according to an embodiment. The printing system 10 includes one or more terminal devices 100 and a printing device 200. Although terminal devices 100A, 100B, 100C, and 100D are shown in FIG. 1, the terminal devices 100A, 100B, 100C, and 100D are referred to as the terminal device 100 when the terminal devices 100A, 100B, 100C, and 100D are referred to without being particularly distinguished.

The printing device 200 is a device having a function of performing printing processing, and is specifically a printer in the embodiment. The printing device 200 is disposed in a hall such as a party hall where people gather, but an installation location of the printing device 200 is not limited thereto. In an environment where the printing device 200 is disposed, a network infrastructure may not be provided. That is, for example, the terminal device 100 and the printing device 200 may not communicate with each other via an access point.

Each terminal device 100 is a terminal such as a personal computer (PC), a smartphone, or a tablet terminal operated by a user. The terminal device 100 is preferably a mobile terminal that can be easily carried by the user, and may not be a mobile terminal. One of the terminal devices 100 provided in the printing system 10 is a device that transmits image data to be printed to the printing device 200 and that requests the printing device 200 to print the image data. In the embodiment, it is assumed that the terminal device 100A is the terminal device 100 that plays this role. The printing system 10 includes the terminal device 100 as a distribution destination of the image data to be printed. According to the embodiment, the terminal devices 100B, 100C, and 100D are terminal devices 100 that play this role.

In the embodiment, for example, the following situation is assumed. A user of the terminal device 100A prints, by the printing device 200, the image data stored by the terminal device 100A for users of the terminal devices 100B, 100C, and 100D. The users of the terminal devices 100B, 100C, and 100D want to obtain, in addition to a printed matter 90 of the image data stored by the terminal device 100A, the image data itself (that is, image data which is electronic data). For example, the above-described image data is a photograph. Specifically, the above-described image data may be a photograph taken by the terminal device 100A. The above-described image data may not necessarily be a photograph. The user of the terminal device 100A may print, by the printing device 200, the image data not only for the users of the terminal devices 100B, 100C, and 100D but also for the user of the terminal device 100A. The embodiment provides a technique capable of distributing the printed matter 90 and distributing the image data even when a network infrastructure is not provided.

In the printing system 10, the terminal device 100 and the printing device 200 communicate with each other conforming to a NAN standard. As will be described later, in the embodiment, the terminal device 100 and the printing device 200 establish wireless communication connection according to a connection sequence defined by the NAN standard. Although four terminal devices 100 are shown as an example in FIG. 1, the number of the terminal devices 100 that communicate with the printing device 200 conforming to the NAN standard may be any number.

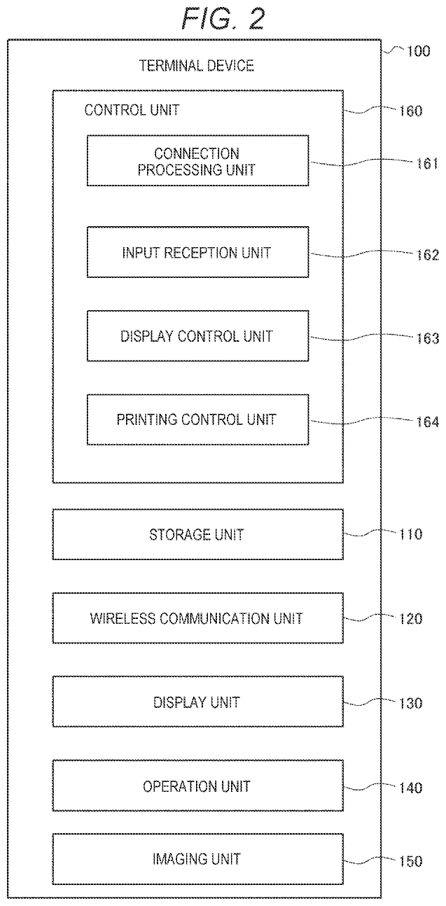

Hereinafter, a specific configuration and processing of the printing system 10 will be described. First, the terminal device 100 will be described. FIG. 2 is a block diagram showing an example of a configuration of the terminal device 100. As shown in FIG. 2, the terminal device 100 includes a storage unit 110, a wireless communication unit 120, a display unit 130, an operation unit 140, an imaging unit 150, and a control unit 160.

The storage unit 110 is a storage device that stores a program for implementing processing of the control unit 160 and data used for processing of the terminal device 100. The storage device may be a nonvolatile storage device such as a hard disk or a flash memory, or may include a memory such as a random access memory (RAM).

The wireless communication unit 120 is hardware that performs wireless communication. That is, the wireless communication unit 120 is a wireless communication interface. The wireless communication unit 120 may include a transmission circuit, a reception circuit, and an antenna.

The display unit 130 and the operation unit 140 are user interfaces. The display unit 130 is implemented by a display or the like that displays various types of information to the user. The operation unit 140 is implemented by a button or the like that receives an input operation from the user. The display unit 130 and the operation unit 140 may be integrally implemented by a touch panel or the like.

The imaging unit 150 is a camera including an imaging element such as a charge coupled device (CCD) sensor or a complementary metal oxide semiconductor (CMOS) sensor. In the embodiment, image data of a photograph taken by the imaging unit 150 and a printed matter thereof may be distributed to the users.

The control unit 160 is a processor such as a central processing unit (CPU) that controls each component of the terminal device 100. The control unit 160 may include a plurality of processors. The control unit 160 reads a program into the memory and executes the program. Accordingly, in the embodiment, the control unit 160 implements functions of a connection processing unit 161, an input reception unit 162, a display control unit 163, and a printing control unit 164.

The connection processing unit 161 searches for the printing device 200 conforming to the NAN standard and establishes the wireless communication connection with the printing device 200 conforming to the NAN standard. Hereinafter, the wireless communication connection conforming to the NAN standard is also referred to as NAN connection. Here, in the embodiment, the wireless communication connection conforming to the NAN standard is specifically a NAN data link. Details of processing of the connection processing unit 161 for establishing NAN connection (NAN data link) between the terminal device 100 and the printing device 200 will be described later.

The input reception unit 162 receives an instruction or information input by the user via the operation unit 140. In particular, the input reception unit 162 of the terminal device 100A receives an instruction corresponding to a printing operation performed by the user via the operation unit 140. The instruction includes an instruction to designate image data to be printed. The instruction may further include an instruction to designate a print setting for printing the image data. Here, the print setting may be a setting for designating a type of a printing medium used for printing, that is, a type of a sheet, or may be a setting for designating an image quality of printing. Here, the image quality may mean a resolution or may mean whether the image quality is colored or monochrome. The print setting is not limited thereto. The print setting may include a setting for designating the number of copies of the image data. For example, the print setting may be a setting for designating a size of a printing medium (sheet) to be used, a setting for designating whether to perform printing without providing a margin on an edge of a printing medium (sheet), a setting for designating whether to perform duplex printing, or the like.

The display control unit 163 controls display performed by the display unit 130. In particular, the display control unit 163 of the terminal device 100A displays a user interface screen for receiving a printing operation.

The printing control unit 164 performs control processing for causing the printing device 200 to perform printing. The terminal device 100A may include at least the printing control unit 164, and the other terminal devices 100B, 100C, and 100D may not necessarily include the printing control unit 164. The printing control unit 164 performs control to transmit, to the printing device 200, image data to be printed and a print request for the image data using the wireless communication connection, that is, the NAN connection established by the connection processing unit 161. When the instruction of the printing operation received by the input reception unit 162 includes an instruction to designate a print setting in addition to an instruction to designate image data to be printed, the printing control unit 164 performs control to transmit the instruction to the printing device 200 using the NAN connection. In the following description, information on an instruction to designate a print setting is also referred to as print setting information.

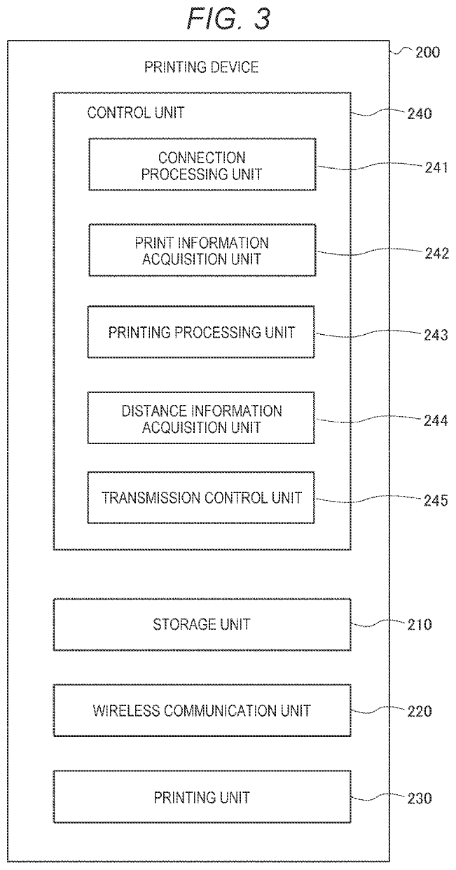

Next, the printing device 200 will be described. FIG. 3 is a block diagram showing an example of a configuration of the printing device 200. As shown in FIG. 3, the printing device 200 includes a storage unit 210, a wireless communication unit 220, a printing unit 230, and a control unit 240. The printing device 200 may further include a user interface such as a touch panel display.

The storage unit 210 is a storage device that stores a program for implementing processing of the control unit 240 and data used for processing of the printing device 200. The storage device may be a nonvolatile storage device such as a hard disk or a flash memory, and may include a memory such as a RAM.

The wireless communication unit 220 is hardware that performs wireless communication. That is, the wireless communication unit 220 is a wireless communication interface. The wireless communication unit 220 may include a transmission circuit, a reception circuit, and an antenna.

The printing unit 230 prints the image data received from the terminal device 100. The printing unit 230 has a printing function for printing on a printing medium such as a sheet. The printing unit 230 includes a printing engine. The printing engine is a mechanical configuration that prints an image on the printing medium using a color material. The printing engine may include a mechanism for printing using ink by, for example, an inkjet method. Alternatively, the printing engine may include a mechanism for printing using toner by, for example, electrophotography. The printing engine may include a transport mechanism for transporting the printing medium.

The control unit 240 is a processor such as a CPU that controls each component of the printing device 200. The control unit 240 may include a plurality of processors. The control unit 240 reads a program into the memory and executes the program. Accordingly, in the embodiment, the control unit 240 implements functions of a connection processing unit 241, a print information acquisition unit 242, a printing processing unit 243, a distance information acquisition unit 244, and a transmission control unit 245.

The connection processing unit 241 performs processing of establishing the NAN connection with the terminal device 100. Details of processing of the connection processing unit 241 for establishing the NAN connection between the terminal device 100 and the printing device 200 will be described later.

The print information acquisition unit 242 acquires image data to be printed from any of the plurality of terminal devices 100 using the NAN connection established by the connection processing unit 241. The print information acquisition unit 242 may further acquire, using the NAN connection, print setting information for designating a print setting for printing the image data. In the embodiment, as described above, as an example, the terminal device 100 that transmits the image data to be printed and the print setting information for printing the image data is the terminal device 100A.

The printing processing unit 243 performs processing for performing printing by the printing unit 230. Specifically, the printing processing unit 243 prints, using the printing unit 230, the image data acquired by the print information acquisition unit 242. When the print information acquisition unit 242 acquires the print setting information in addition to the image data, the printing processing unit 243 controls the printing unit 230 to print the image data according to the setting designated by the print setting information. For example, the printing processing unit 243 performs the printing processing such that the image data is printed by the number of copies designated by the print setting information. For example, when the print setting information includes information on a setting for designating a type of a printing medium used for printing, the printing processing unit 243 may perform the printing processing using a predetermined parameter according to the designated printing medium in order to implement printing suitable for the designated printing medium. Similarly, for example, when the print setting information includes information on a setting for designating an image quality of printing, the printing processing unit 243 may perform the printing processing using a predetermined parameter according to the designated image quality in order to implement printing with the designated image quality.

The distance information acquisition unit 244 acquires, for each of the terminal devices 100, distance information indicating a distance between the printing device 200 and the terminal device 100 measured conforming to the NAN standard. The NAN standard defines a technique in which a device constituting a NAN cluster described later measures a distance between the device and another device constituting the NAN cluster. The technique is also called Ranging. In Ranging, a predetermined frame is transmitted and received between the devices constituting the NAN cluster, and a distance between the devices is calculated based on a transmission and reception time of the predetermined frame. The distance information acquisition unit 244 acquires the distance between the terminal device 100 and the printing device 200 measured using the technique. The distance information acquisition unit 244 may acquire distance information indicating a distance measured by the printing device 200 or may acquire, from the terminal device 100, information indicating a distance measured by the terminal device 100. In the embodiment, the distance information acquisition unit 244 acquires the distance measured conforming to the NAN standard, and may acquire a distance measured according to another technique. In this case, the distance information acquired by the distance information acquisition unit 244 may be information indicating the distance measured by the printing device 200 or information indicating a distance received from another device.

When image data is printed by the printing unit 230, the transmission control unit 245 performs control to transmit the image data to one or more terminal devices 100 using the NAN connection. That is, the transmission control unit 245 performs processing of distributing the image data to be printed to the terminal devices 100 of users. In the embodiment, the transmission control unit 245 determines the terminal device 100 as a transmission destination of the image data based on the distance information acquired by the distance information acquisition unit 244. Specifically, the transmission control unit 245 sets the terminal device 100 whose distance from the printing device 200 is equal to or less than a predetermined threshold (for example, 1 meter) as the transmission destination of the image data. Accordingly, the image data can be transmitted only to the terminal device 100 of the user who approaches the printed matter 90 of the image data. Therefore, it is possible to transmit the image data only to the terminal device 100 of the user who wants to acquire the printed matter 90 and the image data, and it is possible to prevent the image data from being erroneously transmitted to the terminal device 100 of the user other than the user who wants to acquire the printed matter 90 and the image data. Although the transmission control unit 245 uses the distance information as described above in the embodiment, the transmission control unit 245 does not necessarily use the distance information. In this case, the printing device 200 may not include the distance information acquisition unit 244.

The transmission control unit 245 may perform control not to transmit, to the terminal device 100 as a transmission source of image data to be printed, the image data. That is, the transmission control unit 245 may perform control to transmit the image data only to the terminal devices 100 other than the terminal device 100A. This is because the terminal device 100A already stores the image data. Such control can prevent unnecessary transmission of image data. The transmission control unit 245 may determine whether NAN connected terminal devices 100 are the terminal devices 100 that are transmission sources of the image data to be printed using, for example, a media access control (MAC) address of the terminal device 100. In this case, the print information acquisition unit 242 may store, in the storage unit 210, a MAC address of the transmission source notified in the communication for receiving the image data to be printed from the terminal device 100A. Then, the transmission control unit 245 may determine whether a MAC address of each NAN connected terminal device 100 matches the MAC address stored in the storage unit 210, thereby determining whether the NAN connected terminal devices 100 are the terminal devices 100 that are the transmission sources of the image data to be printed.

When the print setting information acquired by the print information acquisition unit 242 includes information for designating a predetermined print setting, the transmission control unit 245 may perform control to transmit the image data to the terminal device 100. When the print setting information does not include information for designating a predetermined print setting, the transmission control unit 245 may perform control not to transmit the image data to any terminal device 100. Accordingly, the image data can be transmitted only when the image data to be printed is data that is highly likely to be distributed to each user. For example, when the print setting information includes information for instructing printing of the image data on a predetermined printing medium, the transmission control unit 245 may perform control to transmit the image data to the terminal device 100. When the print setting information does not include information for instructing printing of the image data on a predetermined printing medium, the transmission control unit 245 may perform control not to transmit the image data to any terminal device 100. Here, the predetermined printing medium is a printing medium such as glossy paper suitable for printing a photograph. In a party hall or the like, there is a need to distribute a group photograph of people gather in the hall as printed matters and to distribute the group photograph as electronic data. That is, when printing using a printing medium such as glossy paper suitable for printing a photograph is designated for image data, it is highly likely that the image data needs to be distributed to each user. Therefore, since the image data can be transmitted by performing the control as described above only when the distribution of the image data is necessary, the unnecessary transmission of the image data can be prevented.

The predetermined print setting for determining whether the image data to be printed is a distribution target is not limited to the designation of the type of the printing medium. For example, the predetermined print setting may be a setting of an image quality in printing. That is, when the print setting information includes information for instructing printing of the image data with a predetermined image quality, the transmission control unit 245 may perform control to transmit the image data to the terminal device 100. When the print setting information does not include information for instructing printing of the image data with a predetermined image quality, the transmission control unit 245 may perform control not to transmit the image data to any terminal device 100. Here, the printing of the image data with the predetermined image quality may be printing with an image quality suitable for printing a photograph, such as high resolution printing (that is, printing with a resolution higher than a predetermined reference) or color printing. The printing of the image data with the predetermined image quality may be one or both of the high resolution printing and the color printing. Even when such control is performed, the same effect as the above-described effect can be attained.

The transmission control unit 245 may end, based on a comparison result between the number of copies of the image data printed by the printing unit 230 and the number of the terminal devices 100 to which the image data is transmitted, the processing of transmitting the image data to the terminal device 100. For example, when the number of copies of the image data is N (N is a natural number), if the transmission of the image data to the N terminal devices 100 is completed, the transmission control unit 245 may end the transmission of the image data. Accordingly, since the image data is transmitted to the terminal devices 100 of the number corresponding to the number of users who acquire the printed matter 90 of the image data, it is possible to appropriately end the transmission processing of the image data. When the user of the terminal device 100 (the terminal device 100A) that transmits the image data to the printing device 200 can also acquire the printed matter 90, the transmission control unit 245 may perform the following control. In this case, for example, when the transmission of the image data to the N−1 terminal device 100 except for the terminal device 100A that is the transmission source of the image data is completed, the transmission control unit 245 may end the transmission of the image data.

The number of the terminal devices 100 as the transmission destinations of the image data may be designated by the user. That is, when the number of the terminal devices 100 to which the image data is transmitted reaches the number designated by the user, the transmission control unit 245 may end the processing of transmitting the image data to the terminal devices 100. In this case, for example, the input reception unit 162 of the terminal device 100A may receive, as an instruction according to the printing operation, an instruction to further designate the number of the terminal devices 100 as the transmission destinations of the image data. Then, the printing control unit 164 may perform control to transmit the instruction to the printing device 200 using the NAN connection. When the number of copies of the image data is 1, the transmission control unit 245 may perform control not to transmit the image data to any terminal device 100. This is because, when the number of copies is one, it is highly likely that the printing is not intended for distribution.

When a predetermined time elapses after the printing of the image data is performed, the transmission control unit 245 may end the processing of transmitting the image data to the terminal devices 100. When the print information acquisition unit 242 acquires new image data to be printed, the transmission control unit 245 may end the transmission processing for old image data. This is merely an example of end conditions of the transmission processing of the image data, and the transmission control unit 245 may end the transmission of the image data when any predetermined end condition is satisfied.

Next, details of processing of the connection processing unit 161 and the connection processing unit 241 for establishing the NAN connection between the terminal device 100 and the printing device 200 will be described. In order to establish the NAN connection, first, the terminal device 100 and the printing device 200 constitute a NAN cluster. Thereafter, the terminal device 100 and the printing device 200 establish the NAN connection, that is, a NAN data link.

In the NAN standard, a period called a discovery window (DW) is defined. The discovery window is mainly a communication period that occurs intermittently for the device to perform service notification and search, and arrives at a predetermined cycle. A set of devices sharing the discovery window is called a NAN cluster. A device operating as a master transmits a discovery beacon for recognizing the NAN cluster to another device that does not yet belong to the NAN cluster. The device operating as the master transmits a synchronization beacon for each device to synchronize with the discovery window. In the embodiment, the terminal device 100 may operate as a master, or the printing device 200 may operate as a master.

Each device constituting the NAN cluster can check a service provided by each device by transmitting and receiving a signal in the discovery window. Specifically, in the discovery window, a signal implemented by a frame of a format called a service discovery frame is transmitted.

A device constituting the NAN cluster can establish a data link capable of intercommunicating with another device constituting the NAN cluster regardless of a DW period. That is, the NAN connection can be established between devices constituting the NAN cluster. In the NAN standard, the above-described data link is called a NAN data link. Hereinafter, a flow until the terminal device 100 and the printing device 200 perform the NAN connection in the embodiment will be described.

First, the terminal device 100 and the printing device 200 share the discovery window. In order to share the discovery window, either the terminal device 100 or the printing device 200 operates as a master. For example, when the terminal device 100 operates as a master, the connection processing unit 161 of the terminal device 100 performs processing of transmitting a discovery beacon and a synchronization beacon from the terminal device 100.

When the terminal device 100 and the printing device 200 share the discovery window, the printing device 200 waits for an inquiry about the service to be broadcast. Then, the connection processing unit 161 of the terminal device 100 performs communication using the discovery window in order to search for the printing device 200 that is a device providing a printing service. Specifically, the connection processing unit 161 broadcasts the inquiry about the service by transmitting a signal using the discovery window defined in the NAN standard. That is, the connection processing unit 161 broadcasts a message for making an inquiry to all other devices constituting the NAN cluster. The message is a message using the service discovery frame. On the other hand, the connection processing unit 241 of the printing device 200 that receives the broadcast of the inquiry responds to the inquiry by transmitting a signal using the discovery window defined by the NAN standard. Accordingly, the terminal device 100 can specify a device that can provide the printing service. Thereafter, the connection processing unit 161 of the terminal device 100 and the connection processing unit 241 of the printing device 200 execute processing of establishing the NAN data link according to a connection procedure conforming to the NAN standard. Accordingly, the NAN connection is established. As described above, in the embodiment, the NAN data link is established between the devices belonging to the same NAN cluster. Accordingly, the terminal device 100 as the transmission source of the image data transmitted to the printing device 200 via the NAN connection, the printing device 200 that receives the image data and transmits the image data to another terminal device 100 via the NAN connection, and the terminal device 100 as the transmission destination of the image data printed by the printing device 200 are devices belong to the same NAN cluster. That is, the transmission control unit 245 of the printing device 200 transmits the image data to another terminal device 100 belonging to the NAN cluster to which the terminal device 100 as the transmission source of the received image data belongs.

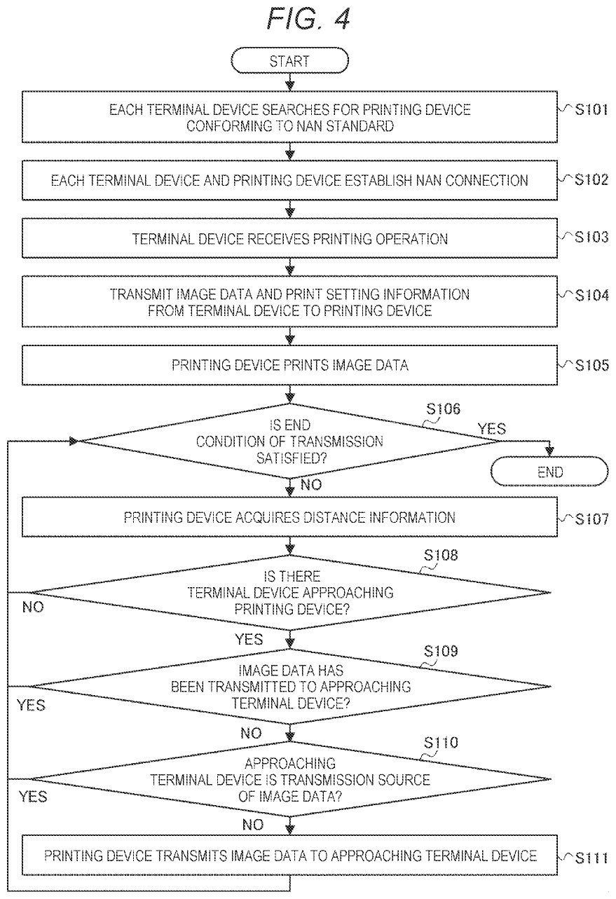

Next, an operation flow of the printing system 10 according to the embodiment will be described. FIG. 4 is a flowchart showing an example of the operation flow of the printing system 10 according to the embodiment. The flowchart shown in FIG. 4 merely shows an example of the operation. Accordingly, for example, an execution order of steps can be changed as long as there is no technical contradiction. Hereinafter, the operation flow of the printing system 10 will be described with reference to FIG. 4.

In step S101, the connection processing unit 161 of each terminal device 100 searches for the printing device 200 by broadcasting an inquiry about a service conforming to the NAN standard. That is, the connection processing unit 161 performs communication using a discovery window, and searches for the printing device 200. At this time, the connection processing unit 161 may search for only the printing device 200 capable of providing a printing service satisfying a specific condition. Then, in step S102, the connection processing unit 161 of each terminal device 100 establishes the NAN connection with the printing device 200. In other words, the connection processing unit 241 of the printing device 200 establishes the NAN connection with each terminal device 100.

Next, in step S103, the input reception unit 162 of the terminal device 100A receives a printing operation performed by the user via the operation unit 140. Then, in step S104, the printing control unit 164 of the terminal device 100A performs control to transmit, to the printing device 200, image data to be printed, print setting information, and a print request for the image data using the NAN connection established in step S102. On the other hand, the print information acquisition unit 242 of the printing device 200 acquires the information transmitted from the terminal device 100A. Accordingly, the image data and the print setting information are transmitted from the terminal device 100A to the printing device 200 via the NAN connection.

Next, in step S105, the printing processing unit 243 of the printing device 200 prints the acquired image data according to the acquired print setting information. Accordingly, the printed matter 90 is generated by the printing device 200.

Next, in step S106, the transmission control unit 245 of the printing device 200 determines whether an end condition of processing of transmitting the image data acquired in step S104 to the terminal device 100 is satisfied. For example, as described above, the transmission control unit 245 may determine that the end condition of the transmission processing is satisfied when a comparison result between the number of copies of the printed matter 90 generated in step S105 and the number of the terminal devices 100 to which the image data is transmitted by the printing device 200 satisfies a predetermined condition. The transmission control unit 245 may determine that the end condition of the transmission processing is satisfied when a predetermined time elapses after the printing of the image data is performed, or may determine that the end condition of the transmission processing is satisfied when the print information acquisition unit 242 acquires new image data to be printed. When the end condition of the transmission processing is satisfied (YES in step S106), the processing ends. Otherwise (NO in step S106), the processing proceeds to step S107.

In step S107, the distance information acquisition unit 244 of the printing device 200 acquires a distance between the printing device 200 and one terminal device 100 for which the NAN connection is established in step S102. Then, in step S108, the transmission control unit 245 of the printing device 200 determines whether there is the terminal device 100 whose distance from the printing device 200 is equal to or less than a predetermined threshold. That is, the transmission control unit 245 determines whether there is the terminal device 100 that approaches the printing device 200. When there is the terminal device 100 that approaches the printing device 200 (YES in step S108), the processing proceeds to step S109, and when there is no terminal device 100 that approaches the printing device 200 (NO in step S108), the processing returns to step S106.

In step S109, the transmission control unit 245 determines whether the image data acquired in step S104 has already been transmitted to the terminal device 100 determined to approach the printing device 200 in step S108. When the image data has not been transmitted to the terminal device 100 yet (NO in step S109), the processing proceeds to step S110, and when the image data has already been transmitted (YES in step S109), the processing returns to step S106.

In step S110, the transmission control unit 245 determines whether the terminal device 100 determined to approach the printing device 200 in step S108 is the terminal device 100 as the transmission source of the image data in step S104. When the terminal device 100 approaching the printing device 200 is not the terminal device 100 as the transmission source of the image data (NO in step S110), the processing proceeds to step S111, and when the terminal device 100 is the terminal device 100 as the transmission source (YES in step S110), the processing returns to step S106.

When the processing proceeds to step S111, the transmission control unit 245 performs control to transmit, using the NAN connection, the image data acquired in step S104 to the terminal device 100 determined to approach the printing device 200 in step S108.

The embodiment is described above. According to the embodiment, even when a network infrastructure environment such as an access point is not provided, image data can be printed using the printing device 200 NAN connected to the terminal device 100. Then, the printing device 200 can transmit image data to be printed to one or more terminal devices 100 via the NAN connection. According to the embodiment, a printed matter of image data and the image data can be distributed to the user, and the convenience for the user can be improved.

Next, a modification of the above-described embodiment will be described. The modification is different from the above-described embodiment in that image data is distributed only to users (terminal devices) belonging to a designated group. The printing system 10 according to the modification includes a terminal device 101 described below instead of the terminal device 100 described above, and includes a printing device 201 described below instead of the printing device 200 described above.

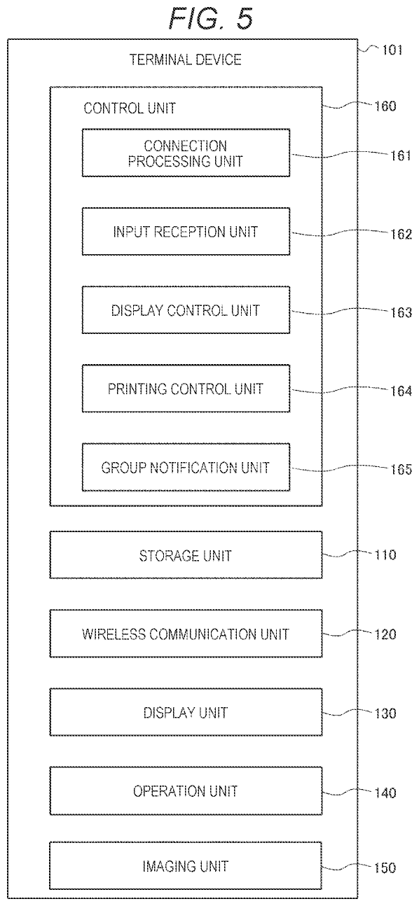

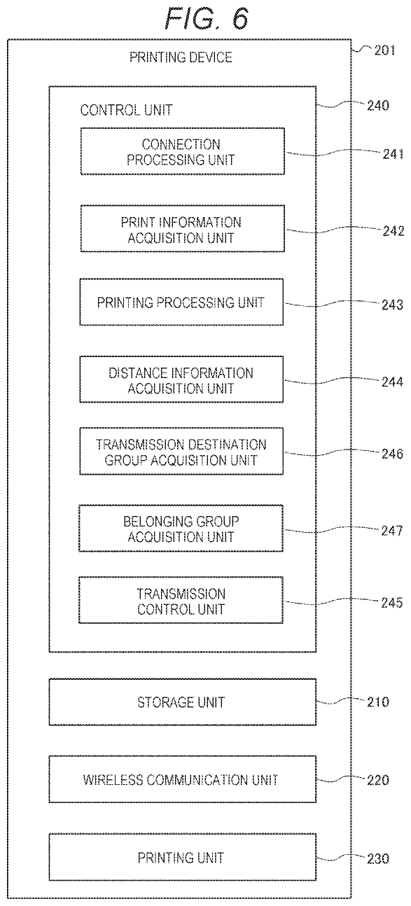

FIG. 5 is a block diagram showing an example of a configuration of the terminal device 101 according to the modification. FIG. 6 is a block diagram showing an example of a configuration of the printing device 201 according to the modification. As shown in FIG. 5, the terminal device 101 is different from the terminal device 100 shown in FIG. 2 in that the terminal device 101 further includes a group notification unit 165. As shown in FIG. 6, the printing device 201 is different from the printing device 200 shown in FIG. 3 in that the printing device 201 further includes a transmission destination group acquisition unit 246 and a belonging group acquisition unit 247. Hereinafter, configurations and processing different from those of the above-described embodiment will be described, and the overlapping description will be appropriately omitted.

First, the terminal device 101 will be described. The group notification unit 165 performs control to transmit group information to the printing device 201 using the NAN connection established by the connection processing unit 161. The group information refers to information including information for identifying a group. Here, the processing of the group notification unit 165 differs depending on whether the terminal device 101 is a device that transmits image data to be printed to the printing device 201 or a device that receives image data from the printing device 201.

The group notification unit 165 of the terminal device 101 that transmits the image data to be printed to the printing device 201 performs control to transmit information (also referred to as first group information) for designating a group as a transmission destination of the image data to the printing device 201 using the NAN connection. In this case, the input reception unit 162 may receive the first group information input by the user via the operation unit 140, and the group notification unit 165 may perform processing of transmitting the first group information. In the case of such a configuration, the user of the terminal device 101 that transmits the image data to be printed to the printing device 201 can designate a desired group as a distribution destination group. The first group information may not necessarily be information received by the input reception unit 162. For example, predetermined first group information may be stored in advance in the storage unit 110.

On the other hand, the group notification unit 165 of the terminal device 101 that receives the image data to be printed from the printing device 201 performs control to transmit, to the printing device 201, information (also referred to as second group information) indicating a group to which the user of the terminal device 101 belongs to using the NAN connection. In this case, the input reception unit 162 may receive the second group information input by the user via the operation unit 140, and the group notification unit 165 may perform processing of transmitting the second group information. The second group information may not necessarily be information received by the input reception unit 162. For example, the group notification unit 165 may read the second group information stored in advance in the storage unit 110, and perform processing of transmitting the second group information.

Next, the printing device 201 will be described. The transmission destination group acquisition unit 246 uses the NAN connection established by the connection processing unit 241 to acquire the above-described first group information for the image data from the terminal device 101 as the transmission source of the image data to be printed. That is, the transmission destination group acquisition unit 246 acquires the group information transmitted by the processing of the group notification unit 165 of the terminal device 101 that transmits the image data to be printed to the printing device 201.

The belonging group acquisition unit 247 acquires, using the NAN connection established by the connection processing unit 241, the above-described second group information from the terminal devices 101 other than the terminal device 101 as the transmission source of the image data to be printed. That is, the belonging group acquisition unit 247 acquires the group information transmitted by the processing of the group notification unit 165 of the terminal device 101 that receives the image data to be printed from the printing device 201.

The transmission control unit 245 according to the modification determines the terminal device 101 as the transmission destination of the image data based on a comparison result between the first group information acquired by the transmission destination group acquisition unit 246 and the second group information of each terminal device 101 acquired by the belonging group acquisition unit 247. Specifically, the transmission control unit 245 determines the terminal device 101, in which the group indicated by the second group information matches the group indicated by the first group information, as the transmission destination of the image data. That is, the transmission control unit 245 sets, as the transmission destination of the image data, the terminal device 101 of the user belonging to a group designated as the transmission destination group.

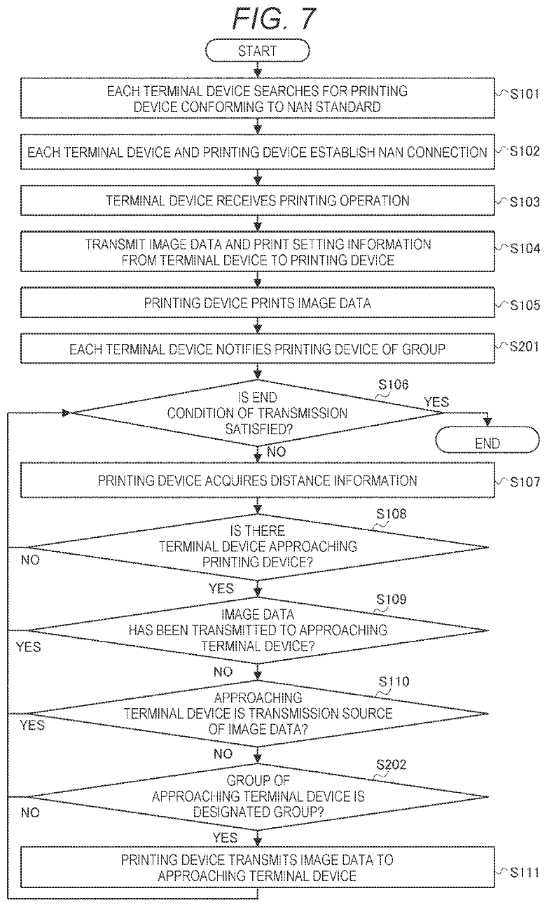

Next, an operation flow of the printing system 10 according to the modification will be described. FIG. 7 is a flowchart showing an example of the operation flow of the printing system 10 according to the modification. The flowchart shown in FIG. 7 is different from the flowchart shown in FIG. 4 in that steps S201 and S202 are added. The flowchart shown in FIG. 7 merely shows an example of the operation. Accordingly, for example, an execution order of steps can be changed as long as there is no technical contradiction.

In the flowchart shown in FIG. 7, after step S105, the processing proceeds to step S201. In step S201, the terminal device 101 NAN connected to the printing device 201 notifies the printing device 201 of the group. That is, the group notification unit 165 of the terminal device 101 that transmits the image data to the printing device 201 in step S104 performs control to transmit the first group information for designating the group as the transmission destination of the image data to the printing device 201 using the NAN connection. The group notification unit 165 of the terminal device 101 other than the above terminal device 101 performs control to transmit, to the printing device 201, the second group information indicating the group to which the user of the terminal device 101 belongs using the NAN connection. Accordingly, the transmission destination group acquisition unit 246 of the printing device 201 acquires the first group information, and the belonging group acquisition unit 247 acquires the second group information. After step S201, the processing proceeds to step S106.

Thereafter, when the processing proceeds and the processing of step S110 is performed, the processing proceeds to step S202. More specifically, in the case of NO in step S110, the processing proceeds to step S202. In step S202, the transmission control unit 245 of the printing device 201 determines whether the group of the terminal devices 101 determined to approach the printing device 201 in step S108 is the group designated as the transmission destination group. That is, the transmission control unit 245 determines whether the group that is indicated by the second group information received from the terminal device 101 determined to approach the printing device 201 in step S108 matches the group indicated by the first group information. When the group indicated by the second group information matches the group indicated by the first group information (YES in step S202), the processing proceeds to step S111, and when the groups do not match (NO in step S202), the processing returns to step S106.

The modification of the embodiment is described above. According to the modification, image data can be distributed only to users belonging to a specific group, and thus convenience is improved.

Although the embodiment and the modification thereof are described above, the present disclosure is not limited to the embodiment and the modifications thereof, and can be appropriately modified without departing from the gist of the present disclosure.

In the example described above, the program includes an instruction group (or a software code) for causing the computer to perform one or more functions described in the embodiment when the program is read by the computer. The program may be stored in a non-transitory computer-readable medium or a tangible storage medium. Examples of the computer-readable medium or the tangible storage medium include, but are not limited to, a random-access memory (RAM), a read-only memory (ROM), a flash memory, a solid-state drive (SSD) or other memory technologies, a CD-ROM, a digital versatile disk (DVD), a Blu-ray (registered trademark) disk or other optical disk storages, a magnetic cassette, a magnetic tape, and a magnetic disk storage or other magnetic storage devices. The program may be transmitted on a transitory computer-readable medium or a communication medium. Examples of the transitory computer-readable medium or the communication medium include, but are not limited to, electrical, optical, acoustic, or other forms of propagating signals.

A part or all of the embodiment described above may be described as in the following appendixes, but are not limited thereto.

### APPENDIX 1

A printing device including:
a connection processing unit configured to establish wireless communication connection with a plurality of terminal devices conforming to a neighbor awareness network (NAN) standard;
a print information acquisition unit configured to acquire image data to be printed from any one of the plurality of terminal devices using the wireless communication connection;
a printing unit configured to print the image data; and
a transmission control unit configured to perform control to transmit the image data to one or more terminal devices included in the plurality of terminal devices using the wireless communication connection when the image data is printed.

### APPENDIX 2

The printing device according to appendix 1, further including:
a distance information acquisition unit configured to acquire, for each of the plurality of terminal devices, distance information indicating a distance between the terminal device and the printing device measured conforming to the NAN standard, in which
the transmission control unit is configured to determine the terminal device as a transmission destination of the image data based on the distance information.

### APPENDIX 3

The printing device according to appendix 1 or 2, in which
the transmission control unit is configured to perform control not to transmit the image data to the terminal device as a transmission source of the image data.

### APPENDIX 4

The printing device according to any one of appendixes 1 to 3, in which
the terminal device as a transmission source of the image data, the terminal device as a transmission destination of the image data, and the printing device are devices belonging to the same NAN cluster.

### APPENDIX 5

The printing device according to any one of appendixes 1 to 4, in which
the print information acquisition unit further acquire, using the wireless communication connection, print setting information for designating a print setting for printing the image data, and
the transmission control unit does not transmit the image data to any of the plurality of terminal devices when the print setting information does not include information for designating a predetermined print setting.

### APPENDIX 6

The printing device according to appendix 5, in which
when the print setting information does not include information for instructing printing of the image data on a predetermined printing medium, the transmission control unit does not transmit the image data to any of the plurality of terminal devices.

### APPENDIX 7

The printing device according to appendix 5, in which
when the print setting information does not include information for instructing printing of the image data at a predetermined image quality, the transmission control unit does not transmit the image data to any of the plurality of terminal devices.

### APPENDIX 8

The printing device according to any one of appendixes 1 to 7, in which
the transmission control unit is configured to end transmission of the image data based on a comparison result between the number of copies of the image data printed by the printing unit and the number of the terminal devices to which the image data is transmitted.

### APPENDIX 9

The printing device according to any one of appendixes 1 to 8, further including:
a transmission destination group acquisition unit configured to acquire, from the terminal devices as transmission sources of the image data, first group information for designating a group of transmission destinations of the image data using the wireless communication connection; and
a belonging group acquisition unit configured to acquire, from the terminal device other than the terminal devices as the transmission sources of the image data among the plurality of terminal devices, second group information indicating a group to which a user of the terminal device belongs using the wireless communication connection, wherein
the transmission control unit is configured to determine the terminal devices as the transmission destinations of the image data based on a comparison result between the first group information and the second group information.

### APPENDIX 10

A method for controlling a printing device, the method including:
establishing wireless communication connection with a plurality of terminal devices conforming to a NAN standard;
acquiring image data to be printed from any one of the plurality of terminal devices using the wireless communication connection;
printing the image data; and
performing control to transmit the image data to one or more terminal devices included in the plurality of terminal devices using the wireless communication connection when the image data is printed.

### APPENDIX 11

A non-transitory computer-readable storage medium storing a program, the program causing a computer to execute:
a connection processing step of establishing wireless communication connection with a plurality of terminal devices conforming to a NAN standard;
a print information acquisition step of acquiring image data to be printed from any one of the plurality of terminal devices using the wireless communication connection;
a printing processing step of performing processing of performing printing of the image data; and
a transmission control step of performing control to transmit the image data to one or more terminal devices included in the plurality of terminal devices using the wireless communication connection when the image data is printed.

What is claimed is:

1. A printing device comprising:
a connection processor configured to establish wireless communication connection with a plurality of terminal devices conforming to a neighbor awareness network (NAN) standard;
a print information acquisition unit configured to acquire image data to be printed from any one of the plurality of terminal devices using the wireless communication connection;
a printing unit configured to print the image data; and
a transmission controller configured to perform control to transmit the image data to one or more terminal devices included in the plurality of terminal devices using the wireless communication connection when the image data is printed.

2. The printing device according to claim 1, further comprising:
a distance information acquisition unit configured to acquire, for each of the plurality of terminal devices, distance information indicating a distance between the terminal device and the printing device measured conforming to the NAN standard, wherein
the transmission controller is configured to determine the terminal device as a transmission destination of the image data based on the distance information.

3. The printing device according to claim 1, wherein
the transmission controller is configured to perform control not to transmit the image data to the terminal device as a transmission source of the image data.

4. The printing device according to claim 1, wherein
the terminal device as a transmission source of the image data, the terminal device as a transmission destination of the image data, and the printing device are devices belonging to the same NAN cluster.

5. The printing device according to claim 1, wherein
the print information acquisition unit further acquire, using the wireless communication connection, print setting information for designating a print setting for printing the image data, and
the transmission controller does not transmit the image data to any of the plurality of terminal devices when the print setting information does not include information for designating a predetermined print setting.

6. The printing device according to claim 5, wherein
when the print setting information does not include information for instructing printing of the image data on a predetermined printing medium, the transmission controller does not transmit the image data to any of the plurality of terminal devices.

7. The printing device according to claim 5, wherein
when the print setting information does not include information for instructing printing of the image data at a predetermined image quality, the transmission controller does not transmit the image data to any of the plurality of terminal devices.

8. The printing device according to claim 1, wherein
the transmission controller is configured to end transmission of the image data based on a comparison result between the number of copies of the image data printed by the printing unit and the number of the terminal devices to which the image data is transmitted.

9. The printing device according to claim 1, further comprising:
a transmission destination group acquisition unit configured to acquire, from the terminal devices as transmission sources of the image data, first group information for designating a group of transmission destinations of the image data using the wireless communication connection; and
a belonging group acquisition unit configured to acquire, from the terminal device other than the terminal devices as the transmission sources of the image data among the plurality of terminal devices, second group information indicating a group to which a user of the terminal device belongs using the wireless communication connection, wherein
the transmission controller is configured to determine the terminal devices as the transmission destinations of the image data based on a comparison result between the first group information and the second group information.

10. A method for controlling a printing device, the method comprising:
establishing wireless communication connection with a plurality of terminal devices conforming to a NAN standard;
acquiring image data to be printed from any one of the plurality of terminal devices using the wireless communication connection;
printing the image data; and
performing control to transmit the image data to one or more terminal devices included in the plurality of terminal devices using the wireless communication connection when the image data is printed.

11. A non-transitory computer-readable storage medium storing a program, the program causing a computer to execute:
a connection processing step of establishing wireless communication connection with a plurality of terminal devices conforming to a NAN standard;
a print information acquisition step of acquiring image data to be printed from any one of the plurality of terminal devices using the wireless communication connection;
a printing processing step of performing processing of performing printing of the image data; and
a transmission control step of performing control to transmit the image data to one or more terminal devices included in the plurality of terminal devices using the wireless communication connection when the image data is printed.
